(19) United States
(12) Patent Application Publication
(10) Pub. No.: US 2004/0172620 A1
(43) Pub. Date: Sep. 2, 2004

(54) Method and apparatus for securely enabling native code execution on a JAVA enabled subscriber device

(75) Inventor: Ricardo Martinez Perez, Plantation, FL (US)

Correspondence Address: POSZ & BETHARDS, PLC, 11250 ROGER BACON DRIVE, SUITE 10, RESTON, VA, 20190, US

(73) Assignee: MOTOROLA, INC.

(21) Appl. No.: 10/376,667

(22) Filed: Feb. 28, 2003

(51) Int. Cl. G06F 9/44; G06F 9/45; G06F 9/00

(52) U.S. Cl. 717/118; 717/148; 719/328

(57) ABSTRACT

A J2ME application (18) stored in memory (14) of a subscriber device (10) includes a Java Native Framework application program interface (24) for providing execution of Framework native code (21) and subscriber device native code (20). An instantiation process (300) determines if the J2ME application (18) has a primary key and accordingly initializing a registration database (48). A registration process (400) registers the Framework native code (21) in the registration database according to an assigned entry identification and dynamically links the Framework native code (21) with subscriber device native code (20), if needed. An execution process (500) executes the Framework native code (21) when the Java Native Framework application program interface is run by the J2ME application (18).

### BACKGROUND OF THE INVENTION

1. Field of the Invention

The present invention relates to Java enabled subscriber devices or subscriber devices, and, more particularly, to a framework for permitting such subscriber devices to run native code from or embedded with a JAVA Application.

2. Description of the Related Art

Conventional subscriber devices such as, for example, the Motorola i85 utilize Java Two Micro Edition (J2ME) applications for providing Java capability. These subscriber devices also include native code of the original equipment manufacturing (OEM) class stored in a subscriber device memory for providing application program interfaces (APIs) for the hardware of the subscriber device. These APIs provide much of the subscriber device functionality by interfacing between a user and subscriber device hardware. The closed environment of Java does not permit a J2ME application to run the native code of the subscriber device. This limitation can be a significant restriction when a subscriber device provider would like to provide updated applications, software patches, or new functionality to improve the capabilities of the subscriber device. More specifically, the updated applications will not function because they will not be able to execute the native code of the subscriber device. Therefore, a subscriber device provider must currently perform a full software release including all the APIs in order to improve subscriber device functionality. The time necessary for creating a full software release can be significantly greater than the time necessary for creating a software patch or adding limited new functionality.

As mentioned above, the closed environment of Java does not permit a J2ME application to run the native code of the subscriber device. However, the J2ME applications may include numerous functions that are commonly provided by the native code. Examples of such functions include string copy, memory, etc. A J2ME application running its own byte code for providing these functions will run slower than if the subscriber device was merely executing its own native code because execution of Java byte code is slower than execution of the native code due to the manner by which Java is compiled (the virtual Java machine). Software techniques such as Just In Time Compilation of Java application have been proposed to increase the execution speed of a J2ME application. However, these techniques significantly increase FLASH and SRAM requirements and are still not as fast as optimized native code.

Therefore, what is needed is a method and device for enabling a J2ME subscriber device to execute native code within a Java environment.

### BRIEF DESCRIPTION OF THE DRAWINGS

The accompanying figures, where like reference numerals refer to identical or functionally similar elements and which together with the detailed description below are incorporated in and form part of the specification, serve to further illustrate a preferred embodiment and to explain various principles and advantages all in accordance with the present invention.

FIG. 1 depicts a block diagram of a preferred embodiment of a subscriber device having Java capability with a J2ME application stored therein.

FIG. 2 depicts the organizational structure of a J2ME application.

FIG. 3 illustrates a flow chart of a preferred method by which the J2ME application initializes the Java Native Framework application program interface.

FIG. 4 illustrates a flow chart of a preferred method of registering Framework native code into a registration database.

FIG. 5 illustrates a flow chart of a preferred method by which the J2ME application executes the Java Native Framework application program interface.

### DETAILED DESCRIPTION OF THE PREFERRED EXEMPLARY EMBODIMENTS

The instant disclosure is provided to further explain in an enabling fashion the best modes of practicing the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions.

Much of the inventive functionality and many of the inventive principles are best implemented with or in software programs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs with minimal experimentation. Therefore, in the interest of brevity and minimization of any risk of obscuring the principles and concepts according to the present invention, further discussion of such software, if any, will be limited to the essentials with respect to the principles and concepts used by the preferred embodiments.

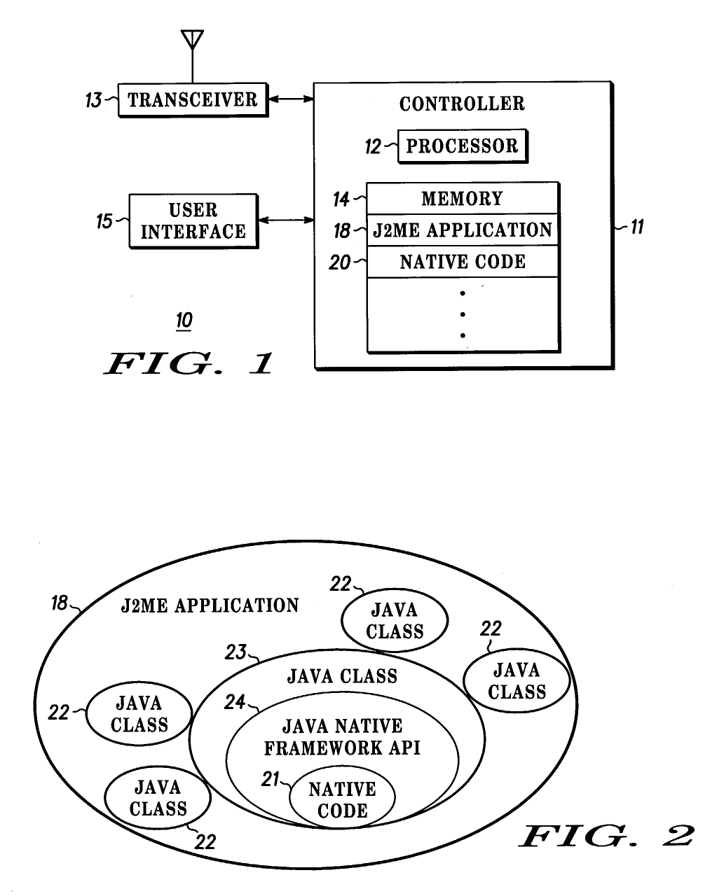

Referring now to the drawings in which like reference numerals refer to like elements, a block diagram of a preferred embodiment of the subscriber device 10 shown in FIG. 1 will be discussed and described. The subscriber device 10 is arranged and constructed for among other tasks, loading and executing a Java Two Micro Edition (J2ME) application 18. Accordingly, the subscriber device 10 includes a controller 11 for controlling other known hardware components such as, for example, a transceiver 13 and user interface 15 including such elements as a speaker, microphone, display, keyboard and so on. The controller 11 is essentially a general-purpose processor and, preferably, includes a processor 12 and an associated memory 14. The processor 12 is, preferably, a known processor based element with functionality that will depend on the specifics of the air interface with the radio access network as well as various network protocols for voice and data traffic. The processor 12 may include one or more microprocessors, digital signal processors, and other integrated circuits depending on the responsibilities of the controller 11 with respect to signal processing duties that are not here relevant. In any event the processor 12 also includes the memory 14 that may be a combination of known SRAM, ROM, EEPROM or magnetic memory.

The memory 14 is used to store among various other items or programs etc., one or more J2ME applications 18, and native code 20. The native code 20 is machine readable code (object code) resulting from the compiling of high level language such as, for example, C or C++ or assembly language code optimized to efficiently execute on the specific processor used by the subscriber device. The native code 20 includes instructions that when executed by the controller 11 included therewith will provide application program interfaces for performing the functions of the subscriber device 10. The native code 20 includes the original equipment manufacturing (OEM) class that provides the application program interfaces (APIs) for interfacing with the hardware components. These APIs may be divided into different license levels representing different access restrictions imposed by the subscriber device manufacturer or purveyor of the software and functionality represented by the API. The native code 20 also includes other functions such as string copy, memory copy, etc. as well as various other routines that are too numerous to mention but that will be evident to one of ordinary skill given a specific subscriber device, etc.

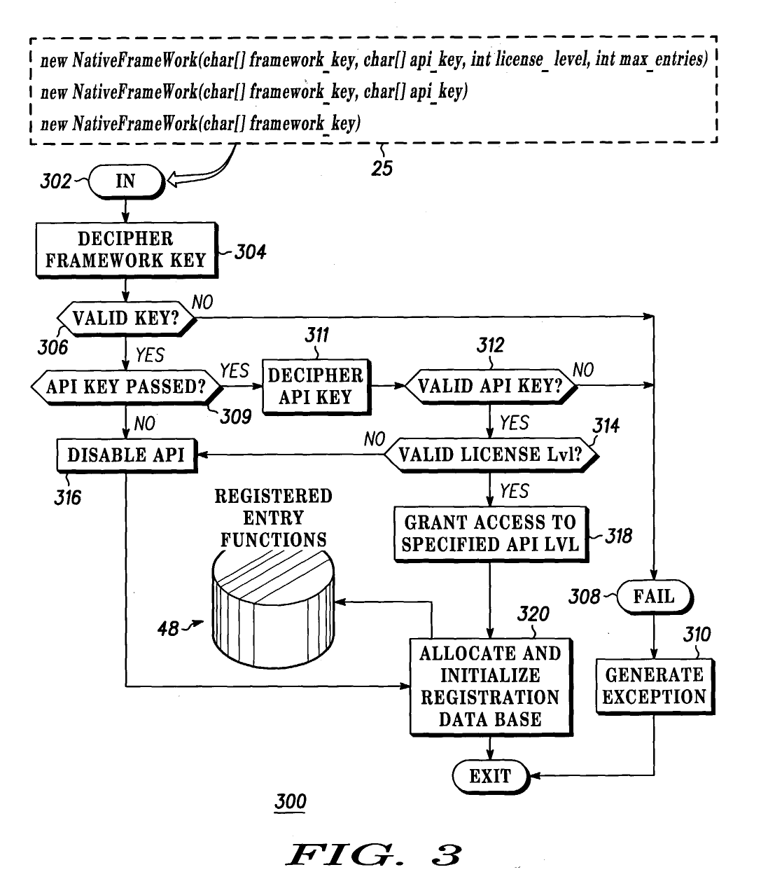

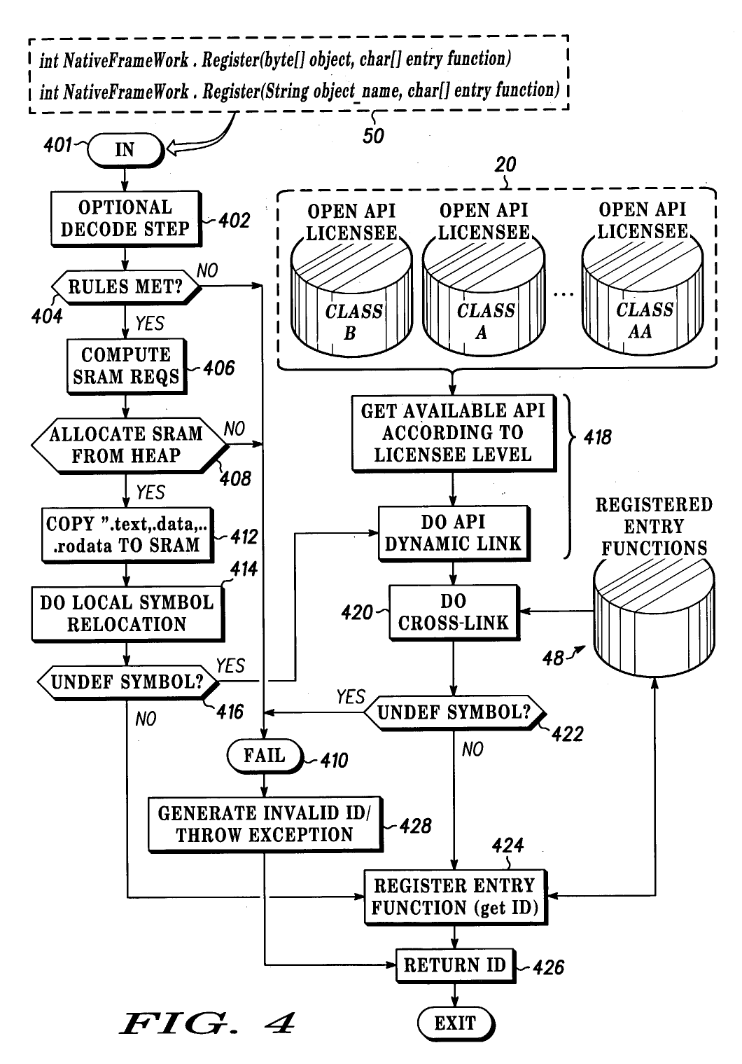

Referring to FIG. 2, the organizational structure of the J2ME application 18 will be discussed. The J2ME application 18 may be, for example, a game or other new functionality, an application to install new Java classes to be used by other J2ME applications, or a program to correct a software glitch or abnormality. The J2ME application 18 includes a plurality of Java classes 22. At least one of the Java classes 22 includes a Java Native Framework Application Program Interface (Framework API) 24 for providing an interface between the Java environment and the native environment such as the subscriber device operating system (native code 20 in FIG. 1). The Framework API 24 may optionally include native code 21 for providing additional functionality to the subscriber device 10 while the J2ME application 18 is running or executing. This native code 21 included in the Framework API 24 may also be permanently installed on the subscriber device 10. The native code 21 provided by the Framework API 24 will be referred to as Framework native code 21 in order to distinguish it from the native code 20 of the subscriber device 10. However, the Framework native code 21 may also be object code that is in a format and optimized for execution on the processor 12 similar to the native code 20. As will be appreciated by those skilled in the art, the J2ME application 18 is executed within a Java environment such as the Java virtual machine (not shown). However, as will be more fully discussed with respect to FIGS. 3-5, the Framework 24 will provide the J2ME application 18 with the capability of executing the Framework native code 21 and native code 20 of the subscribe device in the native environment from within the Java environment.

Referring to FIG. 3, the methodology by which a user initializes the Framework API 24 from within the J2ME application 18 will be discussed. This will be referred to as the instantiation process 300. The instantiation method or process 300 is preferably implemented by a constructor and begins at 302 when the J2ME application 18 instantiates the Framework API 24. As shown by the function prototypes of the constructors depicted at 25, the J2ME application 18 must preferably at a minimum include or pass a primary key that is valid, such as, for example, the framework key (shown in FIG. 3 as framework_key), for successfully instantiating the Framework API 24. However, the constructors 25 could be modified so that the J2ME application 18 would only have to pass the application program interface key (shown in FIG. 3 as api_{—l key) as the primary key or no key at all. It should be noted that the primary key may be embedded within the J}2ME application 18 rather than being directly passed during the instantiation process 300. Thus the framework or API key could be embedded with the J2ME application 18 or other user while it was downloaded or installed from a secure source (not shown). This will help prevent theft of the primary key.

At 304, the primary key or here framework key is deciphered. Deciphering may involve, for example, decrypting the primary key if it was encrypted. At 306, the instantiation process 300 determines whether the primary key passed by the J2ME application 18 is valid. If the primary key is not valid, at 308 the instantiation process 300 fails, generates an exception at 310 and exits.

If, at 306, the primary key is determined to be valid, at 309 the instantiation process 300 determines if the J2ME application 18 passed an application program interface (API) key. The API key may also be embedded in the J2ME application 18 as discussed above. If such an API key was passed, at 311 the instantiation process 300 deciphers the API key and determines whether it is valid at 312. If, at 312 the API key is determined to not be valid, the instantiation process 300 fails as at 308. If, at 312 the API key is determined to be valid, at 314 it is determined whether a valid license level is associated with the API key. This may be done by, for example, comparing this API key to a table of API keys and associated license levels stored in the memory 14 in a secure manner. If no valid license level is associated with the API key, the instantiation process 300 proceeds to 316 where access to the APIs of the OEM class is disabled. Access to these APIs is also disabled at 316 if it was determined at 309 that no API key was passed.

If it is determined at 314 that a valid license level is associated with the API key, at 318 the J2ME application 18 is granted access to the APIs associated with this API key. For example, if the API key was associated with the highest license level, the J2ME application 18 would be granted access to all APIs. Generally, the J2ME application 18 will be granted access to APIs at and below the license level associated with the API key. Accordingly, at 320, the Framework allocates sufficient memory, preferable SRAM for setting up a registration database and initializes the registration database or creates a database including the API that the J2ME application 18 has access to. The initialized registration database is depicted at 48. The instantiation process 300 exits after initializing the registration database 48.

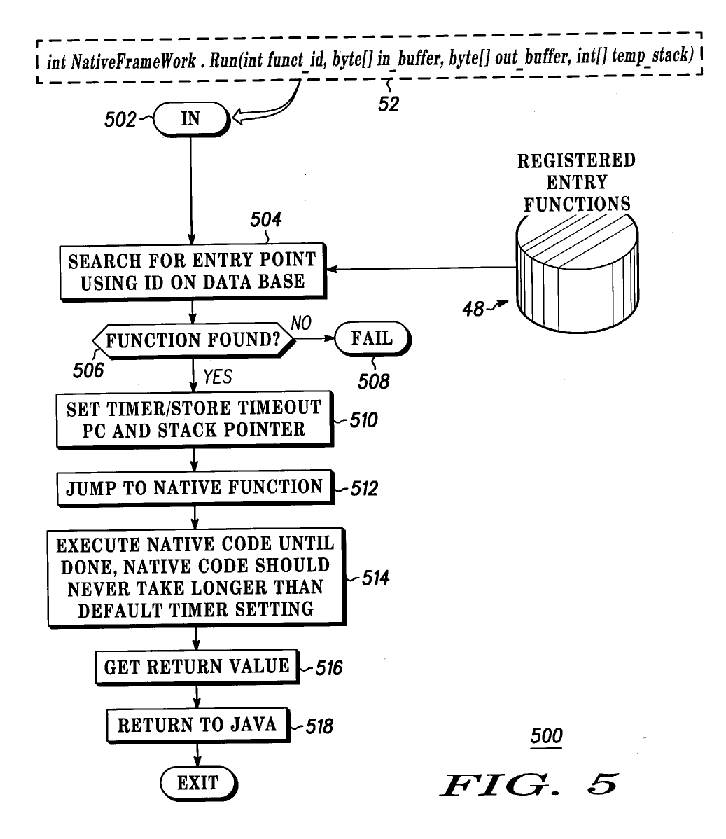

Referring to FIG. 4, the methodology by which the Framework API 24 registers the Framework native code 21 of a Framework native function into the registration database 48 and assigns the native function an entry identification will be discussed. This methodology will be referred to as the registration process 400. The registration process 400 begins at 401 when the J2ME application 18 calls a register function of type Native Framework such as, for example, the function prototypes shown at 50. Then, at 402, the registration process 400 may optionally decode the Framework native code 21 if it is compressed or encrypted. At 404, the registration process 400 determines if the Framework native code 21 meets predetermined rules such as if an executable and linking format of the Framework native code is compatible with the native code 20 of the subscriber device 10 (or the target device architecture). Note that native code for a plurality of different processors may have been downloaded. For example, here the registration process 400 will determine if the Framework native code 21 is a valid object file or if it is linkable. If the Framework native code 21 fails to meet these predetermined rules, the registration process 400 fails at 410 and returns an invalid identification at 428.

If, at 404, the registration process 400 determines that the Framework native code 21 meets the predetermined rules, at 406 the amount of SRAM memory required to store the Framework native code 21 is computed. At 408, the requisite amount of SRAM is allocated from memory or heap memory. If insufficient SRAM is available, the process fails as at 410. At 412, all of the data of the Framework native code 21 is copied to the SRAM. At 414, the registration process 400 does local symbol relocation. More specifically, at 414 the registration process 400 corrects the address of pointers and references to account for the new storage location of the Framework native code 21 in the SRAM.

At 416, it is determined whether any undefined symbols are present with the Framework native code 21. Undefined symbols are most likely references to native code 20, additional Framework native code previously registered in the registration database 48 or corrupted data. If undefined symbols are determined to be present, at 418 an API dynamic link is performed. More specifically, first all of the available APIs in accordance with the API key (determined at 44 of the instantiation process 300) are accessed. Then, the available APIs are compared to the undefined symbol. Native code 20 of matching APIs is dynamically linked to the undefined symbol. As a result, the Framework native code 21 is linked with one or more APIs associated with the license level of the API key.

At 420, cross-linking is performed. More specifically, if there is still an undefined symbol after performing the API dynamic link at 418, the previously registered Framework native code associated with one or more Framework functions is compared to the undefined symbol. Matching Framework native code of the previously registered Framework native functions is cross-linked with the undefined symbol of the Framework native code 21.

At 422, it is determined if an undefined symbol is still present after performing the dynamic linking and the cross linking. If such an undefined symbol is still present, the registration process fails at 410. If, at 422, it is determined that such an undefined symbol is not present, at 424 the Framework native code 21, which now may include one or more dynamically linked APIs or cross-linked Framework native code is assigned a registered entry function identification (entry identification). This entry identification is stored in the registration database 48. At 426, the registration process 400 returns this entry identification and exits. It should be noted that if the registration process 400 fails, it returns an invalid identification that is generated at 428.

Returning to 416, if it is determined here that no undefined symbols are present, than the registration process 400 advances to 424 where the Framework native code 21 is assigned a registered entry function identification, which is subsequently stored in the registration database 48 and returned at 426 as discussed above.

After the J2ME application 18 performs the instantiation process 300 and the registration process 400, the Framework API 24 will be stored in the memory 14 of the subscriber device 10. The Framework API 24 will include the registration database 48 having therein one or more entry identifications. Each of the one or more entry identifications is a reference or pointer referring to Framework native code 21 also stored in memory 41. The Framework native code 21 may then include either dynamically linked native code, cross linked Framework native code or both for being executed by the J2ME application 18. The Framework native code 21 will be stored in the heap portion of the memory 14 if it is intended to only be used during execution of the J2ME application 18. The Framework native code 21 may also be dynamically linked to additional Framework native code that was installed on the subscriber device. The Framework native code 21 is then available to be called during execution by reference to its entry identification (as discussed below) or to be cross-linked to other Framework native code.

Referring to FIG. 5, the process by which the J2ME application 18 utilizes the Framework API 24 for executing native code will be discussed. This will be referred to as the execution process 500. The execution process 500 begins at 502 when the J2ME application 18 runs the Framework API 24 by, for example, calling the run function (NativeFrameWork.Run). As depicted at 52, the entry identification (shown in FIG. 5 as int funct_aid) and parameters for maintaining proper positioning of the program counter are passed by the J2ME application 18 to the Framework API 24 during the call. After passing the entry identification, at 504 the execution process 500 searches for the Framework native code 21 associated with this entry identification in the registration database 48. At 506, it is determined whether the Framework native code 21 associated with this entry identification was successfully found. If the Framework native code 21 was not found, at 508 the execution process 500 fails.

If, at 506, the execution process 500 determines that the native code was successfully found, at 510 the Timer/Store Timeout program counter and the stack pointer are set. At 512, the program counter jumps out of the Java environment and to the Framework native code 21 in heap memory specified by the entry identification. At 514, the Framework native code 21 specified by the entry identification is executed, and the resultant values, such as PASS/FAIL/etc as defined by the application, are returned at 516. Execution of the Framework native code 21 should not take longer than the timer set at 510. It should be noted that native code 20 of the subscriber device 10 may also be executed here as a result of the dynamic linking performed at 418 of the registration process 400. At 518, the program counter returns to the Java environment and the execution process 500 exits and ends.

The Framework native code 21 registered in the registration database 48 will remain stored in SRAM as long as the J2ME application 18 that registered the Framework native code 21 remains active. Preferably, the Framework native code 21 will be cleared from the SRAM and from the registration database 48 as soon as the J2ME application 18 becomes inactive.

Therefore, the present invention provides a Java Native Framework API 24 for a user such as a J2ME application 18. The Java Native Framework API 24 permits the J2ME application 18 to utilize native code 20 of a subscriber device by dynamically linking symbols in the native code 21 of the Java Native Framework to the native code 20 of the subscriber device. Access to the native code 20 of the subscriber device is limited by secure authorization.

The Java Native Framework API 24 can be implemented for improving application processing. For example, a J2ME application utilizing the Java Native Framework API 24 can provide a Java WAP browser with improved WBMP imaging by utilizing the imaging program provided by the subscriber device native code for decoding an image. In comparison, a Java WAP browser utilizing Java byte code for decoding the same image will perform the imaging approximately 8-10 times slower.

In addition, the Java Native Framework API 24 in conjunction with over the air download processes will permit a manufacturer to release a J2ME application for correcting a software glitch in a subscriber device without releasing the native code of the OEM class. Conventionally, manufacturers have had to perform costly subscriber device recalls for correcting software glitches in order to avoid releasing the native code of the OEM class.

The registration process 400 of the Framework API 24 may be modified. For example, although FIG. 4 only shows the Framework native code 21 being stored in the registration database 48, additional Framework native code may optionally be stored with the APIs provided by the native code 20 of the subscriber device. In such a case, the Framework native code 21 will be stored in the general memory associated with the native code 20 so that it is permanently installed on the phone rather than being stored in the SRAM for temporary use. Also, for example, the registration process 400 and the execution process 500 may be modified so that a high level language of the native function could be stored in the memory or databases.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A method for providing native code execution for a Java application, the method comprising:
registering a Framework native function into a registration database according to an entry identification assigned to the Framework native function; and
jumping to Framework native code corresponding to the Framework native function when the Framework native function is called during execution of the Java application by referring to the entry identification assigned to the Framework native function.

2. The method of claim 1, wherein the registering of the Framework native function into the registration database further comprises linking the Framework native code with one or more native application program interfaces.

3. The method of claim 1, wherein the registering of the Framework native function into the registration database further comprises storing the Framework native code in memory associated with one or more native application program interfaces to thereby install the Framework native code.

4. The method of claim 1, further comprising:
determining when the Java application has a valid primary key prior to the registering of the Framework native function into the registration database; and
performing the registering of the Framework native function into the registration database and the jumping to the Framework native code only when the the Java application has the valid primary key.

5. The method of claim 1, further comprising:
determining when the Java application has a valid application program interface key; and
determining a license level associated with the valid application program interface key when the Java application is determined to have the valid application program interface key.

6. The method of claim 5, wherein the registering of the Framework native function into the registration database further comprises linking native code of an application program interface associated with the license level with the Framework native code.

7. The method of claim 5, wherein the registering of the Framework native function into the registration database further comprises cross linking the Framework native function with one or more Framework native functions previously registered in the registration database.

8. The method of claim 5, wherein the determining of when the Java application has the valid application program interface key is performed when the Java application instantiates a Native Framework.

9. The method of claim 1, wherein the registering of the Framework native function into the registration database further comprises decoding the Framework native code.

10. The method of claim 1, wherein the registering of the Framework native function into the registration database further comprises determining if an executable and linking format of the Framework native code is compatible with a target architecture.

11. A Java Native Framework application program interface arranged to provide native code execution by a Java application, the Java Native Framework application program interface when executed by a Java application resulting in the Java application:
registering a Framework native function into a registration database according to an entry identification assigned to the Framework native function; and
jumping to Framework native code corresponding to the Framework native function when the Framework native function is called by the Java application by referring to the entry identification assigned to the Framework native function.

12. The Java Native Framework application program interface of claim 11, further comprising linking the Framework native code with one or more application program interfaces.

13. The Java native framework application program interface of claim 11, further comprising:
determining when the Java application has a valid primary key prior to the registering of the Framework native function into the registration database; and
performing the registering of the Framework native function into the registration database and the jumping to the Framework native code only when the Java application is determined to have the valid primary key.

14. The Java Native Framework application program interface of claim 13, wherein the determining when the Java application has a valid primary key is performed when the Java application instantiates a Native Framework variable.

15. The Java Native Framework application program interface of claim 13, wherein the determining when the Java application has a valid primary key further comprises decrypting a secure key embedded with the Java application at a download time.

16. The Java Native Framework application program interface of claim 11, further comprising:
determining when the Java application has a valid application program interface key; and
determining a license level associated with the valid application program interface key.

17. The Java Native Framework application program interface of claim 16, wherein the registering of the Framework native function further comprises linking the Framework native code with one or more application program interfaces associated with the license level.

18. The Java Native Framework application program interface of claim 16, wherein the registering of the Framework native function into the registration database further comprises cross linking the Framework native code with one of previously registered Framework native code and JAVA classes.

19. The Java Native Framework application program interface of claim 16, wherein the registering of the Framework native function into the registration database further comprises determining if an executable and linking format of the Framework native code is compatible with a target architecture.

20. The Java Native Framework application program interface of claim 11, wherein the registering of the Framework native function into the registration database further comprises storing the Framework native code in memory associated with one or more native application program interfaces to thereby install the Framework native function.

21. A Java Native Framework application program interface comprising a registration database including one or more entry identifications, wherein each of the one or more entry identifications refers to Framework native code stored in memory, the Framework native code including one of dynamically linked native code and cross linked Framework native code for execution by a Java application.

22. The Java Native framework of claim 21, wherein the Framework native code is stored in heap memory.

23. The Java Native framework of claim 21, wherein the Framework native code further includes dynamically linked additional Framework native code.

24. The Java Native framework of claim 21, wherein the dynamically linked native code is native code corresponding to a predetermined license level.

25. The Java Native framework of claim 21, wherein one of the Framework native code and a corresponding Java Class is suitable for execution by any one of a plurality of Java applications.
